(19) United States
(12) Patent Application Publication
(10) Pub. No.: US 2006/0183613 A1
(43) Pub. Date: Aug. 17, 2006

(54) Spreader roll

(75) Inventor: Friedel Niemeyer, Melle (DE)

Correspondence Address: BOURQUE & ASSOCIATES, P.A., 835 HANOVER STREET, SUITE 301, MANCHESTER, NH, 03104, US

(73) Assignee: Stowe Woodward AG, Schloss Holte-Stuckenbrock (DE)

(21) Appl. No.: 10/551,114

(22) PCT Filed: Dec. 6, 2003
(86) PCT No.: PCT/EP03/13858

§ 371 Date: Sep. 19, 2005

(30) Foreign Application Priority Data
Jun. 13, 2003 (DE) 203 09 301.1

(51) Int. Cl. B29C 43/46

(52) U.S. Cl. 492/7; 492/6; 492/16

(57) ABSTRACT

An expander roller includes a tubular roller sleeve 2 adjustable in its curvature that is formed of one-piece tubes made of reinforced plastic/composite material, and that is mounted on a non-rotatable central area by means of bearings 13. The central area is a deformable axis. The outer surfaces of the bearings 13 rest against the inner wall of the roller sleeve 2 or of one of the outer ring shell bushings 3 resting against its inner wall. The inner surfaces of the bearings 13 rest on the upper surface of the deformable axis 1 or of a ring shell bushing 4 firmly surrounding it.

### TECHNICAL FIELD

The invention relates to an expander roller with a tubular roller sleeve adjustable in its curvature that is formed of one-piece tubes made of reinforced plastic/composite material, and that is mounted on a non-rotatable central area by means of bearings.

### BACKGROUND INFORMATION

In an expander roller of the type disclosed in EP 0 932 723 B1, the non-rotatable central area is formed of two relatively short inner tube pieces on its face, onto which the bearings are mounted from within. The tubular pieces may be pivoted, and a curvature of the roller sleeve may result from this pivoting.

The known solution is comparatively expensive. Mounting the roller sleeve on the central area is merely achieved near the roller sleeve ends, while the central area is not supported. Such a mounting arrangement may lead to instability and non-uniform curvature.

### SUMMARY

Based on this State of the Art, it is the task of this invention to form an expander roller of the above-mentioned type such that the adjustable roller sleeve within its roller sleeve may be supported when necessary for the entire length at a central area, whereby the central area is to be simply shaped.

This task is solved by the characteristics of Patent Claim 1.

The shaping of the central area as a deformable axis is a particularly simple solution. It allows as necessary the mounting of the bearings along the entire length of the axis with infinite fine separation adjustment. So that the bearings rest against the inner wall of the roller sleeve with only slight surface pressure, ring shell bushings may be provided between the outer surfaces of the bearings and the inner wall of the roller sleeve that are preferably wider than the bearings. In analogous manner, ring shell bushings may also be provided between the inner surfaces of the bearing and the upper surface of the deformable axis.

Further advantageous embodiments of the invention derive from the Dependent Claims.

### BRIEF DESCRIPTION OF THE DRAWINGS

These and other features and advantages of the present invention will be better understood by reading the following detailed description, taken together with the drawings wherein:

In the following, the two advantageous embodiments of the invention will be described in more detail using Figures, which show:

FIG. 1 is a schematic longitudinal cross-section through a first embodiment example of the expander roller in non-deformed position;

FIG. 2 is the same view as in FIG. 1 in the deformed position;

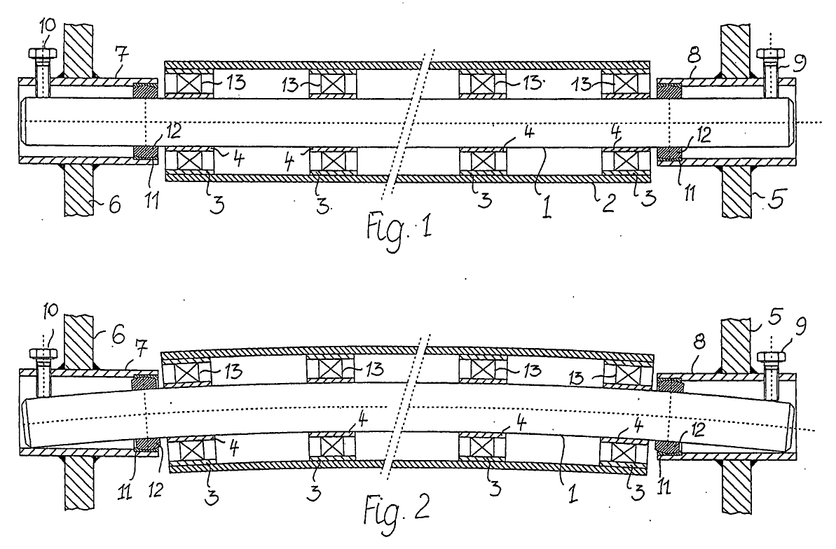

FIG. 1a is a schematic view of a second embodiment example as in FIG. 1; and

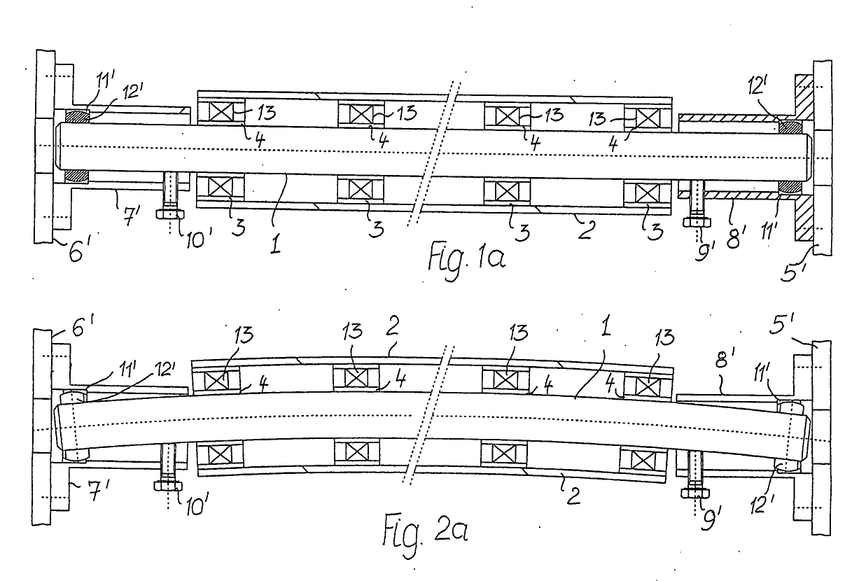

FIG. 2a is a view of a second embodiment example as in FIG. 2 in the deformed position.

### DETAILED DESCRIPTION OF THE PREFERRED EMBODIMENTS

In the various Figures, identical or analogous parts are identified using uniform indexes. They are differentiated from one another merely by the use of apostrophes.

A roller sleeve 2 is mounted on a deformable axis 1 by means of bearings 13. Outer ring shell bushings 3 are positioned between the inner wall of the roller sleeve 2 and the outer surfaces of the bearings 13. Inner ring shell bushings 4 are positioned between the inner surfaces of the bearings 13 and the deformable axis 1. The roller sleeve 2 consists of a plastic/composite material reinforced with glass or carbon fibers (fiberglass or carbon composite). The widths of the inner ring shell bushings 4 and the outer ring shell bushings 3 are greater than the width of the pertinent bearing 13. The bearings are usually roller bearings, e.g., ball bearings.

The ends of the deformable axis 1 are mounted on facing frame areas 5 and 6 of a machine frame. Bushings 7 and 8 are provided in the frame areas 5 and 6 for this. Each of the bushings supports pivotable bearings that consist of outer bearing shells 11 and inner bearing shells 12. Deformation of the axis 1 is possible because of the spherical shape of the outer bearing shell 11 and inner bearing shell 12. For this, adjustment screws 9 and 10 are more or less screwed in deeply, with the result that the ends of the deformable axis move from the position visible in FIG. 1 to the position visible in FIG. 2. Deformation of the roller sleeve 2 occurs simultaneously with the deformation of the axis 1.

The embodiment shown in FIGS. 1a and 2a correspond in the roller area practically completely to those in FIGS. 1 and 2. The only difference is the mounting of the ends of the deformable axis: the mounting locations on the faces and the pivotable axis are merely selected differently. Additionally, the bushings 7′ and 8′ are attached to the frame areas 5′ and 6′ differently.

The deformability of the axis 1 allows installation of the expander roller with its axis 1 in deformed position, as shown in FIGS. 1 and 1a. After subsequent installation of the bearings 13 and the bearing shells 3 and 4 as necessary, and then of the non-deformed roller sleeve that is slid onto it, the curvature of the axis 1 may be altered when the machine is in final installation position. Installation of the expander roller would not be possible without the curvature of the axis, or, in other words, with use of a non-deformable axis.

The present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the allowed claims and their equivalents.

1. An expander roller with a tubular roller sleeve having an inner wall and adjustable in its curvature and that is formed of a one-piece tubes made of reinforced plastic/composite material, and that is mounted on a non-rotatable central area by means of bearings, the expander roller comprising:
the non-rotatable central area including a deformable axis, and wherein outer surfaces of the bearings rest against the inner wall of the roller sleeve or on at least one of a plurality of the outer ring shell bushings resting against the inner wall of the roller sleeve, and wherein inner surfaces of the bearings rest on the upper surface of the deformable axis or on at least one of a plurality of ring shell bushings firmly surrounding it.

2. Expander roller as in claim 1, characterized in that the plastic/composite material is reinforced with glass or carbon fibers.

3. The expander roller as in claim 1, wherein the outer ring shell bushings are wider than the pertinent bearings that rest against the bushings.

4. The expander roller as in claim 1, wherein the inner ring shell bushings are wider than the pertinent bearings that rest against the bushings.

5. The expander roller as in claim 1, wherein the bearings are roller bearings.

6. Expander roller as in claim 5, characterized in that the roller bearings are ball bearings.

7. The expander roller as in claim 1, characterized in that the axis is deformable within the roller sleeve along generally its entire length, and wherein a curvature of the deformed axis is transferred to the tubular roller sleeve via the bearings.
